(19) United States
(12) Patent Application Publication
(10) Pub. No.: US 2004/0109965 A1
(43) Pub. Date: Jun. 10, 2004

(54) Protective sleeving and manufacturing process for producing this type of sleeving

(76) Inventor: Emmanuel Klinklin, Turckheim (FR)

Correspondence Address: STURM & FIX LLP, 206 SIXTH AVENUE, SUITE 1213, DES MOINES, IA, 50309-4076, US

(21) Appl. No.: 10/391,687

(22) Filed: Mar. 18, 2003

Related U.S. Application Data
(60) Provisional application No. 60/365,287, filed on Mar. 18, 2002.

(51) Int. Cl. B32B 1/08

(52) U.S. Cl. 428/36.3

(57) ABSTRACT

Sleeving to protect an object, extending in a longitudinal direction and comprising filaments braided together and filaments interlaced with the braided filaments in the longitudinal direction of the sleeving, the braided filaments consisting of thermoplastic polymer monofilaments and the interlaced filaments consisting of multifilaments, the sleeving being slit in a longitudinal direction to be opened when the object to be protected is inserted, and closing around this object through elastic recall exerted by the thermoplastic monofilaments. According to the invention, the protective sleeving includes a polymer coating adhering to the braided and interlaced filaments on the side destined to surround the object to be protected. The coating is preferably of silicon or acrylic polymer.

### CROSS REFERENCE TO RELATED APPLICATIONS

This application contains disclosure from and claims the benefit under Title 35 United States Code § 119(e) of U.S. Provisional Application Serial No. 60/365,287, filed Mar. 18, 2002 and entitled “Protective Sleeving and Manufacturing Process for Producing this Type of Sleeving”.

### BACKGROUND OF THE INVENTION

1. Field of the Invention

The invention concerns sleeving to protect an object, for example an electrical wiring harness of the type such as is used in an automobile, boat or aircraft. The invention also includes a manufacturing process for protective sleeving.

These sleevings are usually produced using monofilaments and multifilaments made of thermoplastic materials such as polypropylenes, polyamides or polyesters. They are usually in the form of a sleeving and may have a longitudinal opening with each edge of this opening overlapping. This geometric shape facilitates the insertion of electrical wires and cables. These products are usually intended to provide mechanical protection such as good abrasion and puncture resistance while retaining great flexibility and small overall dimensions.

In particular, the invention concerns sleeving designed to protect an object, extending in a longitudinal direction and comprising filaments which are braided together and filaments interlaced with the braided filaments along the longitudinal direction of the sleeving. The braided filaments include thermoplastic polymer monofilaments and the interlaced filaments include multifilaments.

2. Description of the Related Art

The international patent application published under number WO 9206235 describes protective sleeving of this type. The braided filaments are made of polyester monofilaments and the interlaced filaments are made of polyamide multifilaments. The polyester monofilaments support the protective sleeving around a balanced diameter. The polyamide multifilaments are interlaced with the braided filaments in a longitudinal direction to prevent the protective sleeving from deformation when subjected to stress in that direction.

The polyamide multifilaments also provide this type of protective sleeving with puncture resistance in a longitudinal direction. However, in a direction which is perpendicular to the longitudinal direction, the braiding allows the filaments to slide over each other, leading to less puncture resistance. In comparison, protective sleeving produced by loom weaving provides good puncture resistance in both the sleeving's longitudinal and transverse directions. An example of this type of sleeving is particularly described in document U.S. Pat. No. 4,784,886. However, protective sleeving can be produced much faster by braiding the filaments than by weaving the same filaments.

### BRIEF SUMMARY OF THE INVENTION

One of the aims of the invention is to modify a protective sleeving of the type described above to give it greater puncture resistance in a direction which is perpendicular to the longitudinal direction. The invention also aims to modify this type of protective sleeving so that it can be manufactured using a braiding process which is faster than a weaving process.

For this purpose, the invention aims to provide protective sleeving for an object, extending longitudinally and comprised of filaments braided together and filaments interlaced with the braided filaments along the longitudinal direction of the sleeving, the braided filaments being made of thermoplastic polymer monofilaments and the interlaced filaments of multifilaments, the sleeving being split longitudinally so that it can be opened for insertion of the object to be protected and closed by elastic recall exerted by the thermoplastic monofilaments, characterized in that it includes a polymer coating adhering to the braided filaments and the interlaced filaments on the side destined to surround the object to be protected.

The coating is preferably of silicon or acrylic polymer.

The invention is extended to a process for manufacturing sleeving to protect an object, comprising flat braiding of the first filaments made of thermoplastic monofilaments and interlacing of the second filaments with the first in the longitudinal direction of braiding, the second filaments consisting of multifilaments; then the braided and interlaced filaments are wound in a spiral through application of a heat source to the thermoplastic filaments followed by cooling, characterized in that it includes the deposit of a polymer coating which adheres to the braided and interlaced filaments, on the side destined to surround the object to be protected.

The coating is preferably applied flat before the braided and interlaced filaments are wound in a spiral and the spiral winding is performed in such a way as to place the coating on the side destined to surround the object to be protected, or the coating is deposited on the side destined to surround the object to be protected by reopening the sleeving along the longitudinal slit after winding the braided and interlaced filaments in a spiral.

### BRIEF DESCRIPTION OF THE DRAWINGS

Further advantages of the invention will be revealed on reading the description of the two manufacturing methods, illustrated by drawings.

FIG. 1 is a partial view of the protective sleeving open and flattened.

FIG. 2 is a schematic view of the first device designed for use in a process to manufacture the protective sleeving illustrated in FIG. 1, in which a coating of polymer is deposited before the sleeving is wound into a spiral.

FIG. 3 is a perspective view of the protective sleeving.

FIG. 4 is a schematic view of the whole second device designed for use in a process to manufacture the protective sleeving illustrated in FIG. 1, in which a coating of polymer is deposited after the filaments are wound in a spiral, by reopening the protective sleeving.

In the rest of the description, a single component is given the same reference in the various figures.

### DETAILED DESCRIPTION OF THE INVENTION

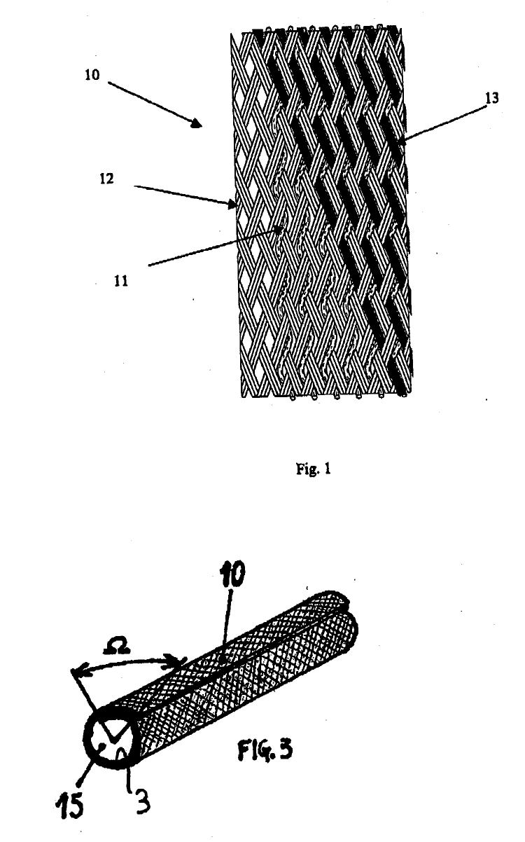

Protective sleeving is produced by braiding using a braiding machine modified to allow flat braiding. This first stage of the manufacturing process is well known within the industry. In the example shown in FIG. 1, the braiding involves three thermoplastic monofilaments, ref. 12, of polyester for example, and two multifilaments, 11 and 13, these being made of polyamide for example. The monofilaments typically have a diameter of between 0.15 millimetres (mm) and 0.50 mm.

The multifilaments, 13 and monofilaments, 12, are braided very tightly to increase stability. The multifilaments, 11, are interlaced with the braided filaments in the longitudinal direction of braiding to counter any longitudinal deformation of the braiding when it is subjected to stress in that direction. Pressure zones due to contact between the braided filaments and the interlaced filaments are likely to engender static friction which limits deformation of the braiding when it is subjected to stress perpendicular to the longitudinal direction, by limiting the opening of the weave.

The braiding stage must be followed by the shaping stage. A source of heat is applied to the thermoplastic filaments to roll them into a spiral along an axial direction corresponding to the longitudinal direction of the protective sleeving thus formed. The filaments are then cooled to hold them in the spirally wound position corresponding to the sleeving's balance diameter. A more detailed discussion of the shaping stage is found in U.S. Pat. No. 4,929,478, especially column 3, lines 49-54 and column 4, lines 45-53, which is incorporated herein by reference.

The protective sleeving manufactured from a flat braiding device includes a slit in the longitudinal direction which is useful for opening the protective sleeving when inserting the object to be protected. The polyester monofilaments close the protective sleeving around the object to be protected, by elastic recall back to the position corresponding to the sleeving's balance diameter.

According to the invention, the manufacturing process includes an adhesive coating of polymer 3 deposited onto the braided and interlaced filaments on the side destined to surround the object to be protected, i.e. the inside of the sleeving.

In a first production method, the coating 3 is deposited flat before the braided and interlaced filaments are wound in a spiral and the spiral winding is performed so as to position the coating on the side destined to surround the object to be protected.

To execute the invention, the flat braid, 10, is initially passed through a coating system 20, known as such, which deposits a fine coating of polymer, 21, on one side of the braiding, this side, 15, corresponding to the inside of the protective sleeving when it is closed around the object to be protected. The polymer, 21, used in the process, described schematically in FIG. 3, may be a silicon elastomer, the excellent temperature resistance of this product meaning that the shaping phase can use heat energy to dry the coating without any fear of damaging it.

For shaping, a source of heat is used and the braiding is passed through two dies, 30 and 40, in a first heating jig to initiate permanent deformation of the flat braid. The shapes defined in the two dies allow gradual and continuous deformation of the braided strip and the two edges of the braid, 14 and 16, overlap by an angle Ω which may vary from 10 to 350°. For reasons of productivity, increasing production speed may require a second heating jig to be added.

On leaving the heating jig, the protective sleeving is cylindrical and is cooled very rapidly by an air-cooling system, 50. This sudden, rapid cooling fixes the multifilaments and the thermoplastic monofilaments in a balanced position. The balanced position for the protective sleeving is therefore sleeving with a longitudinal slit with the two edges overlapping on part of the perimeter. When the product is handled in a normal atmosphere, to insert electrical wires or cables, it automatically returns to its original position which causes the sleeving to close.

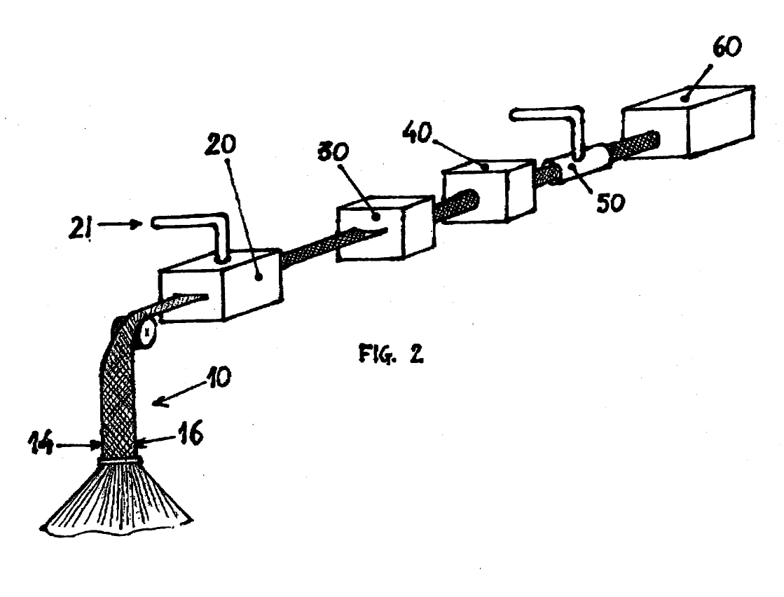

A cutting machine, 60, used to prepare lengths of protective sleeving, is shown in FIG. 2.

Using a second method of execution, the coating 3 is deposited on the side destined to surround the object to be protected, by reopening the sleeving on either side of the longitudinal slit, after the braided and interlaced filaments have been wound into a spiral.

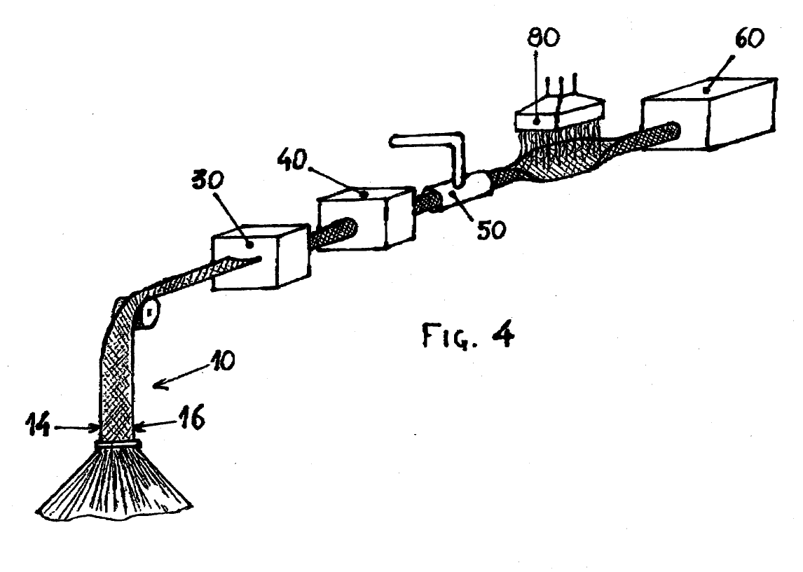

As shown in FIG. 4, the manufacturing process performs the polymer coating operation after shaping. When the polymer coating operation uses an acrylic, this stage must be completed after shaping, because of the very high temperatures used for shaping which an acrylic polymer could not support. Acrylic polymers can also be dried in a normal atmosphere while the protective sleeving is being packaged.

The polymer coating is deposited on the inside of the protective sleeving by a spray device 80, known as such. To ensure that the inner surface of the braided protective sleeving is presented facing the spray system, the sleeving is reopened after shaping to cover the entire width of the flat braided section. Reopening the protective sleeving is not shown in the figure, but is performed by two dies, positioned just before and just after the spray device, 80, so that a fine layer of acrylic polymer is deposited on the entire width of the braid. It is also planned to position the polymer coating using a device which performs the coating operation using a roller.

The protective sleeving produced according to the process described above is more cost effective because it is produced by braiding and the polymer coating operation is compatible with a continuous production process. The protective sleeving has better puncture resistance due to the presence of the polymer coating, since this forms a continuous envelope on the inside of the sleeving. The coating limits the opening of the braided mesh when the sleeving is subjected to stress perpendicular to the longitudinal direction and also, the composition of the polymer allows the coating to be deformed without tearing in this perpendicular direction.

Obviously many modifications and variations of the present invention are possible in light of the above teachings. It is therefore, to be understood that, within the scope of the appended claims, the invention may be practiced otherwise than as specifically described.

1. Sleeving to protect an object, extending in a longitudinal direction comprising filaments braided together and filaments interlaced with the braided filaments in the longitudinal direction of the sleeving, the braided filaments consisting of thermoplastic polymer monofilaments and the interlaced filaments comprising of multifilaments, the sleeving being slit in a longitudinal direction to be opened when the object to be protected is inserted, and closing around this object through elastic recall exerted by the thermoplastic monofilaments, wherein the sleeving includes a polymer coating adhering to the braided and interlaced filaments on the side destined to surround the object to be protected and being deformed when the braided filaments and the interlaced filaments are subjected to a stress perpendicular to the longitudinal direction.

2. Sleeving to protect an object according to claim 1, wherein the coating is silicon.

3. Sleeving to protect an object according to claim 1, wherein the coating is acrylic polymer.

4. A manufacturing process to produce a sleeving to protect an object according to claim 1, comprising flat braiding of the first filaments including thermoplastic polymer monofilaments and interlacing of the second filaments including multifilaments, with respect to the first filaments in the longitudinal direction of braiding, then winding the braided and interlaced filaments into a spiral by applying a heat source to the thermoplastic filaments followed by cooling, wherein the process includes application of a polymer coating which adheres to the braided and interlaced filaments on the side surrounding the object to be protected.

5. A manufacturing process to produce a sleeving to protect an object according to claim 2, comprising flat braiding of the first filaments including thermoplastic polymer monofilaments and interlacing of the second filaments including multifilaments, with respect to the first filaments in the longitudinal direction of braiding, then winding the braided and interlaced filaments into a spiral by applying a heat source to the thermoplastic filaments followed by cooling, wherein the process includes application of a polymer coating which adheres to the braided and interlaced filaments on the side surrounding the object to be protected.

6. A manufacturing process to produce a sleeving to protect an object according to claim 3, comprising flat braiding of the first filaments including thermoplastic polymer monofilaments and interlacing of the second filaments including multifilaments, with respect to the first filaments in the longitudinal direction of braiding, then winding the braided and interlaced filaments into a spiral by applying a heat source to the thermoplastic filaments followed by cooling, wherein the process includes application of a polymer coating which adheres to the braided and interlaced filaments on the side surrounding the object to be protected.

7. A manufacturing process according to claim 4, wherein the coating is applied flat before the braided and interlaced filaments are wound into a spiral and in that the winding into a spiral is performed in such a way as to deposit the coating on the side destined to surround the object to be protected.

8. A manufacturing process according to claim 4, wherein the coating is applied on the side destined to surround the object to be protected, by reopening the sleeving on either side of the longitudinal slit after winding the braided and interlaced filaments into a spiral.
